(19) United States
(12) Patent Application Publication
(10) Pub. No.: US 2010/0265531 A1
(43) Pub. Date: Oct. 21, 2010

(54) SECURE PRINTING SYSTEM, PRINTER DRIVER DEVICE AND STORAGE MEDIUM

(75) Inventor: Tsuyoshi Nitta, Osaka-shi (JP)

Correspondence Address: HESPOS & PORCO LLP, 110 West 40th Street, Suite 2501, NEW YORK, NY, 10018, US

(73) Assignee: KYOCERA MITA CORPORATION, Osaka-shi (JP)

(21) Appl. No.: 12/759,245

(22) Filed: Apr. 13, 2010

(30) Foreign Application Priority Data
Apr. 17, 2009 (JP) 2009-100501

(51) Int. Cl. G06F 15/00

(52) U.S. Cl. 358/1.14

(57) ABSTRACT

An image forming apparatus at first stores only a process request of a secure print job and authentication information relating to the secure print job which take up only a tiny part of a storage area of a job. Upon receiving operation information indicating the authentication information stored in the job memory, the image forming apparatus receives a print data relating to the secure print job associated with the authentication information from a user terminal and prints it.

### BACKGROUND OF THE INVENTION

1. Field of the Invention

The present invention relates to a secure printing system, a printer driver device and a storage medium.

2. Description of the Related Art

There are printing systems each constructed by connecting a plurality of information processing apparatuses (hereinafter, referred to as user terminals in some cases) and an image forming apparatus including a print engine via a network to enable a print request by sending a print data to the image forming apparatus from each user terminal.

Some of such printing systems include a secure printing function to meet a wide variety of users' needs.

The secure printing function is a function which enables the execution of a document-related print job while maintaining confidentiality. Specifically, in the case of, for example, an instruction from a certain user terminal to an image forming apparatus to print a document required to be confidential such as a classified document or a confidential document together with an instruction to set secure printing, the image forming apparatus temporarily saves a secure print job in a job memory without immediately executing it. The secure print job is executed after an operation for authentication such as the input of a password by a user who came to this apparatus.

In the image forming apparatus including such a secure printing function, it is a general rule to save the secure print job data in the job memory until the secure print job is printed by the user. However, if secure print jobs are received without limitation and saved in the job memory, it is inevitable to consequently give rise to a capacity shortage of the job memory.

There is a secure printing system for secure printing by an image forming apparatus upon an instruction from a computer using a printer driver, wherein the printer driver includes an information adding device for adding a deletion period which runs out after the lapse of a specified time to end up with the deletion of a secure print job or information on a specified time at which the secure print job is deleted and the image forming apparatus includes a deleting device for deleting a secure print job, which has not yet output when the deletion period lapses or the deletion time is reached after the output of the secure print job from the computer.

According to this secure printing system, the capacity shortage of the job memory can be avoided by setting or managing a valid period (deletion period or deletion time) for each secure print job.

However, with this secure printing technology, a valid period needs to be set for each secure print job to avoid the capacity shortage of the job memory. Such a setting operation is cumbersome and may impair user convenience.

### SUMMARY OF THE INVENTION

An object of the present invention is to provide a novel secure printing system capable of preventing a capacity shortage of a job memory without impairing user convenience when an image forming apparatus receives secure print jobs without limitation.

In order to accomplish this object, one aspect of the present invention is directed to a secure printing system, comprising an image forming apparatus including a print engine for printing a print data relating to a secure print job when the print data is transmitted thereto; and a user terminal having a printer driver for controlling the operation of the print engine installed therein and so constructed as to be able to instruct secure printing to the image forming apparatus, wherein the image forming apparatus includes a process request registering section for receiving and registering a process request of the secure print job and authentication information relating to the secure print job; an operation information obtaining section for obtaining operation information indicating the authentication information relating to the secure print job; a secure print job searching section for searching a secure print job relating to the authentication information indicated by the operation information from registered contents of the process request registering section every time the operation information indicating the authentication information is obtained by the operation information obtaining section; and a print permission issuing section for issuing a print permission of the extracted secure print job to the corresponding user terminal when the corresponding secure print job is extracted by the secure print job searching section, and the user terminal includes a process request transmitting section for transmitting the process request of the secure print job and the authentication information relating to the secure print job to the image forming apparatus; a secure print data accumulating section for temporarily accumulating a print data relating to the secure print job; a print permission obtaining section for obtaining the print permission of the secure print job from the image forming apparatus having received the process request and the authentication information relating to the secure print job and registered them in the process request registering section; and a print data transmitting section for causing the print engine to print the print data by transmitting the print data relating to the secure print job to the image forming apparatus when the print permission of the secure print job is obtained.

These and other objects, features and advantages of the present invention will become more apparent upon reading the following detailed description. Further, advantages of the present invention will become more apparent in the following description with reference to accompanying drawings.

### BRIEF DESCRIPTION OF THE DRAWINGS

FIG. 1 is a functional block diagram showing a schematic construction of a secure printing system according to one embodiment of the invention,

FIG. 2 is an external view of an operation panel unit in an image forming apparatus,

FIG. 3 is an operational flow chart showing data exchange between a user terminal and the image forming apparatus when the user terminal makes an entry relating to a secure print job to the image forming apparatus, and

FIG. 4 is an operational flow chart showing data exchange between the user terminal and the image forming apparatus when a print output relating to the secure print job is made by a user who came to the image forming apparatus.

### DETAILED DESCRIPTION OF THE PREFERRED EMBODIMENTS

Hereinafter, a secure printing system, a printer driver device and a storage medium according to one embodiment of the present invention are described in detail with reference to the drawings.

As the secure printing system according to the embodiment of the present invention is illustrated a system constructed by connecting an information processing apparatus (hereinafter, referred to as a user terminal) such as a personal computer and an image forming apparatus including a print engine by a network so that secure printing can be instructed from the user terminal to the image forming apparatus.

### [Schematic Construction of the Secure Printing System According to the Embodiment of the Present Invention]

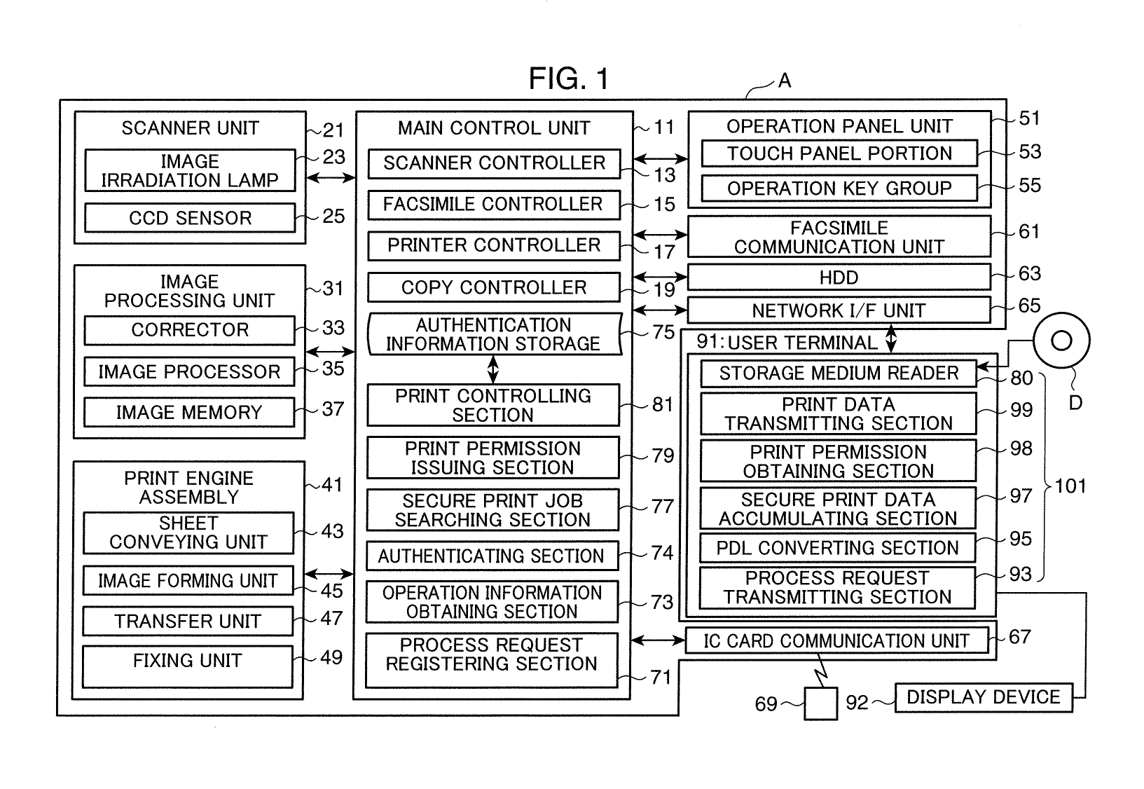

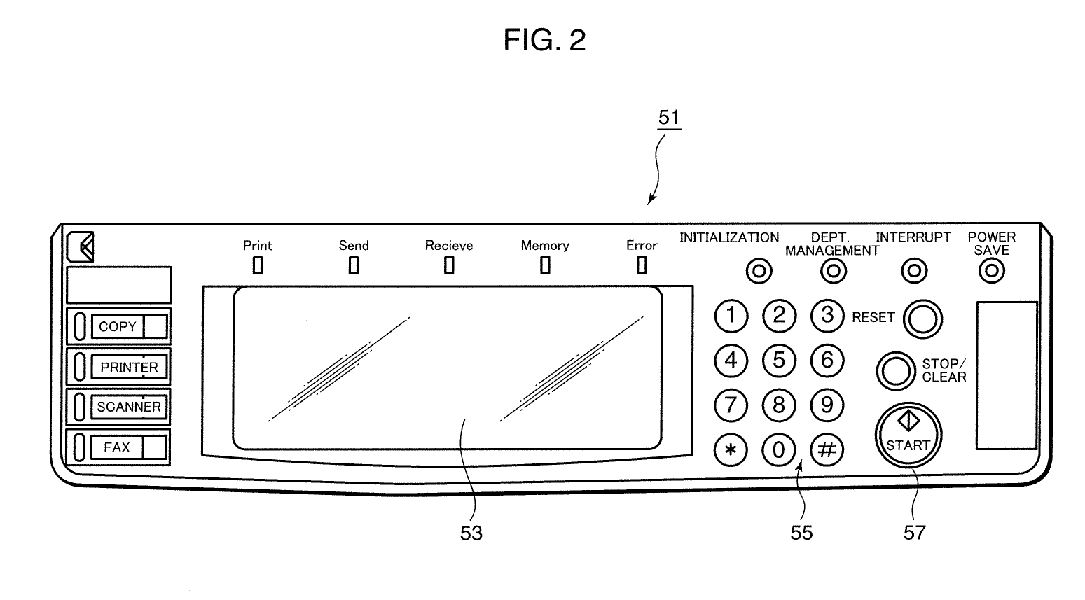

FIG. 1 is a functional block diagram showing a schematic construction of the secure printing system according to the embodiment of the invention, and FIG. 2 is an external view of an operation panel unit in the image forming apparatus.

An image forming apparatus A is so constructed as to permit a user requesting a login to this apparatus via an operation panel unit or a network to use various functions thereof by requesting the input of user identification information and a password (authentication information).

The image forming apparatus A is capable of using, for example, various functions including a copy job, a FAX transmission job, a print job and a network transmission (mail transmission, data transmission) job, and is controlled by a main control unit 11 comprised of a microcomputer, a dedicated hardware circuit and the like.

As input/output devices connected with this main control unit 11 to carry out various functions, this apparatus includes a scanner unit 21, an image processing unit 31, a print engine assembly 41, the operation panel unit 51, a facsimile transmission unit 61, a HDD (hard disk drive) 63, a network I/F (interface) unit 65 and an IC card communication unit 67.

The main control unit 11 incorporates a scanner controller 13 for controlling an operation for realizing a scanner function, a facsimile controller 15 for controlling an operation for realizing a facsimile function, a printer controller 17 for controlling an operation for realizing a printer function and a copy controller 19 for controlling an operation for realizing a copy function, and controls operations of the entire apparatus.

The main control unit 11 is also provided with a process request registering section 71 for receiving and registering a process request and authentication information relating to a secure print job and sent from a user terminal 91 to be described later, an operation information obtaining section 73 for obtaining various pieces of operation information relating to image formation including authentication information relating to a secure print job, an authenticating section 74 for authenticating the validity of an accessing user, an authentication information storage 75 for storing the authentication information for authenticating whether or not an accessing user has a valid access authorization, a secure print job searching section 77 for searching a secure print job relating to authentication information based on an operation information from registered contents of the process request registering section 71 every time the operation information of the authentication information relating to the secure print job is obtained by the operation information obtaining section 73, a print permission issuing section 79 for issuing a print permission of the extracted secure print job to the corresponding user terminal 91 when the corresponding secure print job is extracted by the secure print job searching section 77, and a print controlling section 81 for controlling the print engine assembly 41 to perform a print data process relating to a secure print job sent from the user terminal 91 to the image forming apparatus A.

The scanner unit 21 includes an image irradiation lamp 23 and a CCD (charge coupled device) sensor 25 constituting an unillustrated scanner. The scanner unit 21 irradiates a document with the image irradiation lamp 23 and receives the reflected light by the CCD sensor 25, thereby reading an image from the document and outputting an image data corresponding to the read image to the image processing unit 31.

The image processing unit 31 includes a corrector 33, an image processor 35 and an image memory 37. The image processing unit 31 processes an image data read by the scanner unit 21 using the corrector 33 and the image processor 35 if necessary and stores the processed image data in the image memory 37 or outputs it to the print engine assembly 41, the facsimile transmission unit 61 or the like. The corrector 33 applies a specified correction process such as a level correction or a gamma correction to an image data read by the scanner unit 21. The image processor 35 performs various processings such as compression or expansion and enlargement or reduction of an image data.

The print engine assembly 41 that functions to execute a print job in the embodiment of the present invention includes a sheet conveying unit 43 comprised of unillustrated sheet cassette, feed roller and the like, an image forming unit 45 comprised of unillustrated photoconductive drum, exposure device, developing device and the like, a transfer unit 47 comprised of unillustrated transfer roller and the like and a fixing unit 49 comprised of unillustrated fixing roller and the like. The print engine assembly 41 prints an image on a sheet using an image data read by the scanner unit 21, a document or image data transmitted from a client PC (personal computer) or the like by a LAN (local area network) via the network I/F unit 65, or a fax data received from an external facsimile machine using the facsimile communication unit 61. Specifically, the sheet conveying unit 43 conveys a sheet to the image forming unit 45, the image forming unit 45 forms a toner image corresponding to the image data, the transfer unit 47 transfers the toner image to the sheet and the fixing unit 49 forms an image by fixing the toner image to the sheet.

As shown in FIGS. 1 and 2, the operation panel unit 51 includes a touch panel portion 53 and a function key unit 55. The operation panel unit 51 is used by a user to perform an operation relating to the scanner function, the facsimile function, the printer function, the copy function and the like and feeds an operation command and the like by the user to the main control unit 11.

The touch panel portion 53 is constructed by a touch panel unit as a combination of a touch panel and a color LCD (liquid crystal display) or the like, and displays various operation screens, e.g. information on a document size, a copy size, the number of sets of copy to be made at the time of executing the copy function, and also displays operation buttons used by the user to input various operation commands by touching corresponding parts. The touch panel portion 53 is also used to display a screen urging an operation for authentication relating to a secure print job on a display screen.

The operation key group 55 includes a plurality of operation keys for receiving operation inputs by the user. Specifically, the operation key group 55 includes a start key 57, a numerical pad and the like that are operated to instruct the execution of, e.g. the copy function and the scanner function. These plurality of operation keys are used by the user, for example, to selectively execute a key input operation of a necessary one of various functions including the facsimile function, the copy function, the printer function and the scanner function. Specifically, they are used, for example, when the user enters an input using the numerical pad to select keys relating to a password at the time of using the secure printing function.

The facsimile communication unit 61 includes a coder/decoder (not shown), a modem (not shown) and a NCU (network control unit) (not shown). The facsimile communication unit 61 transmits an image data of a document read by the scanner unit 21 to a facsimile machine via a telephone line and receives an image data transmitted from a facsimile machine or the like.

The HDD (hard disk drive) 63 temporarily stores an image data read by the scanner unit 21 or a document-related electronic data transmitted from a client PC via the network I/F unit 65. The image data or document-related electronic data stored in the HDD 63 is not only used in the image forming apparatus A, a program and a storage medium, but also confirmed by the client PC or the like via the network I/F unit 65 or transferred to a specified folder of the client PC, an FTP server or the like in some cases.

The network I/F unit 65 uses a network interface (10/100 Base-TX) or the like to control transmission and reception of various data to or from a plurality of user terminals 91 such as client PCs connected via the LAN.

Specifically, the network I/F unit 65 relays, for example, a process request and authentication information data relating to a secure print job and transmitted from a certain user terminal 91 to the image forming apparatus A to the process request registering section 71. The network I/F unit 65 relays a print permission of a secure print job issued by the print permission issuing section 79 to a print permission obtaining section 98 in order to transmit it to the user terminal 91. Further, the network I/F unit 65 relays a print data relating to a secure print job and transmitted from a certain user terminal 91 to the image forming apparatus A to the print controlling section 81. Furthermore, the network I/F unit 65 fulfills specified functions other than the above.

The IC card communication unit 67 has a function of detecting access of a card key 69 such as an IC tag possessed by a user, reading user identification information stored in the card key 69 and transferring it to the main control unit 11.

In order to provide a novel secure printing system which does not give rise to a capacity shortage of a job memory such as the image memory 37 even in the case of receiving secure print jobs without limitation, a printer driver 101 is installed as a program having various functions described below for controlling the operation of the print engine assembly 41 in the user terminal 91 including a display device 92 capable of displaying a print dialogue.

Thus, in this embodiment, the user terminal 91 functions as a printer driver device for controlling the operation of the print engine assembly 41 of the image forming apparatus A. Since the user terminal 91 functions as the printer driver device in this way, it includes a storage medium reader 80 for reading a storage medium D storing a program constituting a printer driver 101 to be described below.

The program read from such a storage medium D is stored in an unillustrated storage medium such as a memory or a hard disk.

Although the user terminal 91 functions as the printer driver device in this embodiment, the present invention is not limited to this example. It goes without saying that various devices having the printer driver 101 installed therein function as printer driver devices.

The printer driver 101 shown in FIG. 1 is composed of functional sections described below. Specifically, the printer driver 101 includes a process request transmitting section 93 for transmitting a process request and authentication information relating to a secure print job to the image forming apparatus A, a PDL converting section 95 for converting a confidential document or the like to be securely printed into a PDL (page description language) data recognizable by the image forming apparatus A, a secure print data accumulating section 97 for temporarily accumulating a print data relating to a secure print job in an unillustrated memory, a print permission obtaining section 98 for obtaining a print permission of the secure print job from the image forming apparatus A having received and registered the process request and the authentication information relating to the secure print job, and a print data transmitting section 99 for transmitting the print data relating to the secure print job to the image forming apparatus A when the print permission of the secure printing job is obtained.

### [Operation of the Secure Printing System According to the Embodiment of the Present Invention]

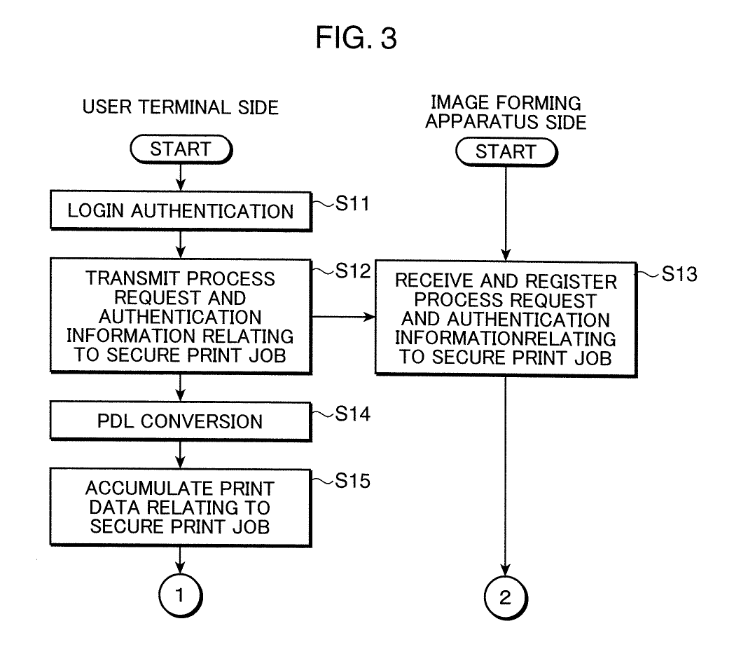

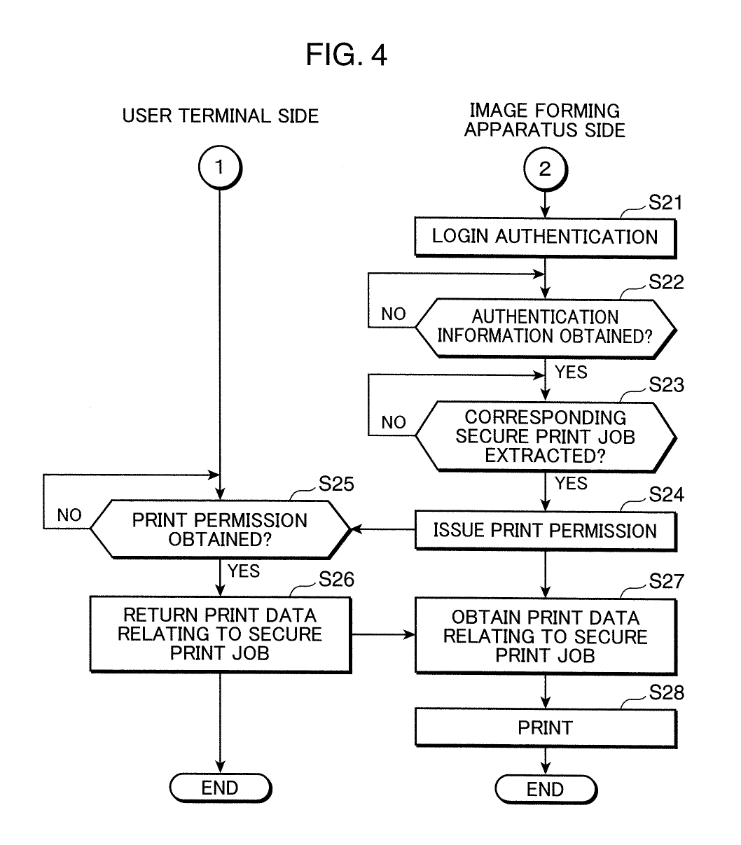

Next, the operation of the secure printing system according to the embodiment of the present invention is described with reference to FIGS. 3 and 4. FIG. 3 is an operational flow chart showing data exchange between the user terminal 91 and the image forming apparatus A when an entry relating to a secure print job is made from the user terminal 91 to the image forming apparatus A, and FIG. 4 is an operational flow chart showing data exchange between the user terminal 91 and the image forming apparatus A when a print output relating to the secure print job is made by a user who came to the image forming apparatus A.

First of all, there is described data exchange between the user terminal 91 and the image forming apparatus A when the entry relating to the secure print job is made from the user terminal 91 to the image forming apparatus A.

As shown in FIG. 3, when a user wishing to enter a secure print job for a confidential document inputs his user identification information and authentication information (authentication information) by way of the user terminal 91, the authenticating section 74 performs a login authentication as to whether or not the user who logged in is a valid user by verifying the input user identification information and the like with the user identification information and the like registered beforehand in a user management database (not shown) (Step S11).

If the logged-in user is recognized to be a valid user as a result of this login authentication, the process request transmitting section 93 transmits a process request and authentication information relating to the secure print job to the image forming apparatus A (Step S12). Here, the authentication information relating to the secure print job is input when the user relating to the secure print job actually comes to the image forming apparatus A and instructs a print output of this secure print job. This authentication information may be different from or same as the user identification information and password (authentication information) used in the login authentication in Step S11.

On the other hand, the process request registering section 71 of the image forming apparatus A receives and registers the process request and the authentication information relating to the secure print job and transmitted from the user terminal 91 (Step S13). At this time, in the image forming apparatus A, registration data of the process request and the authentication information relating to the secure print job takes up only a tiny part of a memory storage area, wherefore there is no likelihood that the job memory such as the image memory 37 encounters a capacity shortage.

The PDL converting section 95 of the user terminal 91 converts a print document data such as a confidential document to be securely printed, which data was transmitted from an application software pre-installed in the user terminal 91, into a PDL (page description language) data recognizable by the image forming apparatus A (Step S14). In response to this, the secure print data accumulating section 97 temporarily accumulates the print data (PDL code data) relating to the secure print job after this conversion (Step S15).

Next, there is described data exchange between the user terminal 91 and the image forming apparatus A when the print output relating to the secure print job is made by the user who came to the image forming apparatus A.

As shown in FIG. 4, the IC card communication unit 67 constantly monitors access of the IC card key 69. At this time, if the user who came to the image forming apparatus A sets his card key 69 on an IC card reader/writer, the IC card communication unit 67 detects the access of the IC card key 69, reads the user identification information stored in the IC card key 69 and transfers the read user identification information of the IC card key 69 to the authenticating section 74.

In response to this, the authenticating section 74 verifies the user identification information transferred from the IC card communication unit 67 with the user identification information and the like pre-registered in the authentication information storage 75, thereby performing a login authentication as to whether or not the user logged in via the card key authentication is a valid user (Step S21).

If the logged-in user is authenticated to be valid as a result of the login authentication in Step S21, the authenticating section 74 waits until operation information indicating the authentication information via the operation information obtaining section 73 is input (Step S22). If the authentication information relating to the secure print job is the same as the authentication information used in the login authentication in Step S21, a process in the next Step S23 follows with the authentication information used in the log authentication in Step S21.

In Step S23, the secure print job searching section 77 searches the secure print job relating to the authentication information obtained in Step S22 from the registered contents of the process request registering section 71. If the corresponding secure print job is extracted (“Yes” in Step S23) as a result of this search, the print permission issuing section 79 issues a print permission of the extracted secure print job to the corresponding user terminal 91 (Step S24).

On the other hand, when the print permission obtaining section 98 in the user terminal 91 obtains the print permission of the secure print job transmitted from the image forming apparatus A to the user terminal 91 (“Yes” in Step S25), the obtained print permission is transferred to the print data transmitting section 99.

In response to this, the print data transmitting section 99 transmits the print data relating to the secure print job accumulated in the secure print data accumulating section 97 for this time to the image forming apparatus A (Step S26).

On the other hand, the print controlling section 81 in the image forming apparatus A controls the print engine assembly 41 to perform the process for this print data (Step S28) upon obtaining the print data relating to the secure print job and transmitted from the user terminal 91 (Step S27). In this way, the printing process relating to the secure print job is performed by the print engine assembly 41.

### [Functions and Effects of the Secure Printing System According to the Embodiment of the Present Invention]

In the secure printing system according to the embodiment of the present invention, the user terminal 91 transmits a process request and authentication information relating to a secure print job to the image forming apparatus A from the process request transmitting section 93. At this time, a confidential document or the like to be securely printed is PDL converted by the PDL converting section 95 and a print data relating to the secure print job after this PDL conversion is temporarily accumulated in the secure print data accumulating section 97.

On the other hand, in the image forming apparatus A, the process request registering section 71 receives and registers the process request and the authentication information relating to the secure print job and transmitted from the process request transmitting section 93 of the user terminal 91. The secure print job searching section 77 searches a secure print job relating to authentication information indicated by operation information from the registered contents of the process request registering section 71 every time the operation information indicating the authentication information is obtained by the operation information obtaining section 73. When the corresponding secure print job is extracted by the secure print job searching section 77 as a result of this search, the print permission issuing section 79 issues a print permission of the extracted secure print job to the corresponding user terminal 91.

In the user terminal 91 having received the issued print permission of the secure print job, the print permission obtaining section 98 obtains the print permission of this secure print job. Then, the print data transmitting section 99 transmits the print data relating to this secure print job to the image forming apparatus A.

After the specified data exchange between the user terminal 91 and the image forming apparatus A as described above, the print engine assembly 41 performs the process for the print data relating to the secure print job and transmitted from the user terminal 91 to the image forming apparatus A.

As described above, in the secure printing system according to the embodiment of the present invention, the registered data of the process request and the authentication information relating to the secure print job takes up only a tiny part of the memory storage area and the actual print data relating to the secure print job and generally tending to take up a large part of the storage area of the job memory (image memory 37) is accumulated in the user terminal 91 while the authentication information is input by the user, the print permission of the secure print job relating to the inputted authentication information is issued to the corresponding user terminal 91 and the print data relating to the secure print job is transmitted from the user terminal 91 to the image forming apparatus A.

Thus, a capacity shortage of a job memory of an image forming apparatus can be prevented without requiring a user to set a valid period (deletion period or deletion time) for each secure print job.

Accordingly, a novel secure printing system can be provided which can prevent a capacity shortage of the job memory without impairing user convenience when the image forming apparatus A receives secure print jobs without limitation.

In the printer driver 101, the process request transmitting section 93 may be so constructed that, when print data relating to a plurality of secure print jobs are accumulated in the secure print data accumulating section 97, authentication information common to the respective secure print jobs can be set. According to this construction, time and effect for an operation for authentication can be reduced upon an actual output of the respective secure print jobs as compared with the case where it is required to individually set authentication information for each secure print job.

In the printer driver 101, the secure print data accumulating section 97 may be so constructed that, when print data relating to a plurality of secure print jobs are accumulated, the respective print data can be combined into a single print data.

Further, in the printer driver 101, the process request transmitting section 93 may be so constructed that, when print data relating to a plurality of secure print jobs are accumulated and combined into a single print data in the secure print data accumulating section 97, common authentication information can be set for the single combined print data. According to this construction, similar to the above, time and effect for an operation for authentication can be reduced upon an actual output of the respective secure print jobs as compared with the case where it is required to individually set authentication information for each secure print job.

### [Miscellaneous]

The present invention is not limited to the above embodiment and can be appropriately changed without departing from the scope as claimed and the gist or technological thought of the present invention that can be read from the entire specification, and secure printing systems accommodating such changes are also included in the technical scope of the present invention.

Specifically, although the image forming apparatus A is operating in a card key authentication mode in the above embodiment, the present invention is not limited to such an embodiment and is also applicable to the image forming apparatus A operating in a panel authentication mode in which the use of the apparatus is permitted through a request of a key input operation of user identification information and a password to a user.

The concept of the “user” in the present invention includes not only, of course, an individual user, but also, for example, a department user including every member of staff in a certain department.

Further, the concept of the user terminal 91 (information processing apparatus) having the printer driver according to the present invention installed therein includes, for example, a personal computer (PC), a work station (WS), a personal digital assistant (PDA) and the like.

The present invention can be embodied in the form of a program or a storage medium. For example, a printer control function according to one embodiment of the present invention may be executed by a host computer having received a program (i.e. program constituting the printer driver 101) to be installed from the outside. In this case, the present invention can be applied as it is even if an information group including the program (i.e. program constituting the printer driver 101) is supplied to the host computer by a storage medium such as a CD-ROM, a flash memory or an FD or from an external storage medium via a network.

The object of the present invention can be accomplished also by supplying a storage medium D storing a program code of software (i.e. printer driver 101) realizing the functions of the above embodiment to a system or apparatus (e.g. user terminal 91) and causing a computer (or CPU or MPU) of the system or apparatus to read and execute the program code stored in the storage medium D. In this case, the program code read from the storage medium D itself causes the computer of the apparatus to realize novel functions, wherefore the storage medium storing this program code constitutes the present invention.

For example, a flexible disk, a hard disk, an optical disk, a magneto-optical disk, a CD-ROM, a CD-R, a DVD-ROM, a magnetic tape, a nonvolatile memory card, a ROM, an EEPROM, a silicon disk or the like can be used as the storage medium D for supplying the program code.

A mode in which the functions of the above embodiment are realized not only by the execution of the read program code by the computer, but also by the execution of some or all of actual processes by an OS (operating system) or the like working on the computer based on an instruction of the program code is also included in the technical scope of the present invention.

Further, a mode in which, after the program code read from the storage medium D is written in a memory of a function extension board inserted into the computer or a function extension unit connected to the computer, the functions of the above embodiment are realized by the execution of some or all of actual processes by a CPU or the like of the function extension board or the function extension unit based on an instruction of the program code is also included in the technical scope of the present invention.

Finally, it goes without saying that the functions of the above embodiment can be enjoyed by the system or the apparatus downloading and reading the program constituting the software (i.e. printer driver 101) from a server, a database or the like on a network using a communication program.

The above specific embodiment mainly includes inventions having the following constructions.

A secure printing system according to one aspect of the present invention comprises an image forming apparatus including a print engine for printing a print data relating to a secure print job when the print data is transmitted thereto; and a user terminal having a printer driver for controlling the operation of the print engine installed therein and so constructed as to be able to instruct secure printing to the image forming apparatus, wherein the image forming apparatus includes a process request registering section for receiving and registering a process request of the secure print job and authentication information relating to the secure print job; an operation information obtaining section for obtaining operation information indicating the authentication information relating to the secure print job; a secure print job searching section for searching a secure print job relating to the authentication information indicated by the operation information from registered contents of the process request registering section every time the operation information indicating the authentication information is obtained by the operation information obtaining section; and a print permission issuing section for issuing a print permission of the extracted secure print job to the corresponding user terminal when the corresponding secure print job is extracted by the secure print job searching section, and the user terminal includes a process request transmitting section for transmitting the process request of the secure print job and the authentication information relating to the secure print job to the image forming apparatus; a secure print data accumulating section for temporarily accumulating a print data relating to the secure print job; a print permission obtaining section for obtaining the print permission of the secure print job from the image forming apparatus having received the process request and the authentication information relating to the secure print job and registered them in the process request registering section; and a print data transmitting section for causing the print engine to print the print data by transmitting the print data relating to the secure print job to the image forming apparatus when the print permission of the secure print job is obtained.

According to this construction, in the image forming apparatus having the process request and the authentication information relating to the secure print job registered in the process request registering section, when certain authentication information is inputted by a user, a secure print job relating to the authentication information indicated by this operation information is searched from the registered contents of the process request registering section. When the corresponding secure print job is extracted as a result of this search, a print permission of the extracted secure print job is issued to the corresponding user terminal.

On the other hand, in the user terminal having received the issued print permission from the image forming apparatus, the print data relating to the secure print job accumulated until the issuance of the print permission is transmitted to the image forming apparatus.

After the above specified data exchange between the user terminal and the image forming apparatus, the print engine performs the process for the print data relating to the secure print job and transmitted from the user terminal to the image forming apparatus.

In short, according to this construction, the registered data of the process request and the authentication information relating to the secure print job takes up only a tiny part of a memory storage area and the actual print data relating to the secure print job and generally tending to take up a large part of the storage area of a job memory is accumulated in the user terminal while the authentication information is input by the user, the print permission of the secure print job relating to the inputted authentication information is issued to the corresponding user terminal and the print data relating to the secure print job is transmitted from the user terminal to the image forming apparatus.

Thus, a capacity shortage of the job memory of the image forming apparatus can be prevented without requiring the user to set a valid period (deletion period or deletion time) for each secure print job.

Accordingly, a novel secure printing system can be provided which can prevent a capacity shortage of a job memory without impairing user convenience when an image forming apparatus receives secure print jobs without limitation.

A printer driver device according to another aspect of the present invention for controlling the operation of a print engine for printing a print data when the print data relating to a secure print job is transmitted comprises a process request transmitting section for transmitting a process request of the secure print job and authentication information relating to the secure print job to an image forming apparatus; a secure print data accumulating section for temporarily accumulating a print data relating to the secure print job; a print permission obtaining section for obtaining the print permission of the secure print job from the image forming apparatus having received the process request and the authentication information relating to the secure print job and registered them in a process request registering section; and a print data transmitting section for causing the print engine to print the print data by transmitting the print data relating to the secure print job to the image forming apparatus when the print permission of the secure print job is obtained.

According to this construction, the print data relating to the secure print job is temporarily accumulated in the secure print data accumulating section and the process request and the authentication information relating to the secure print job are transmitted to the image forming apparatus by the process request transmitting section.

When the print permission of the secure print job is obtained by the print permission obtaining section from the image forming apparatus having the process request and the authentication information relating to the secure print job registered in the process request registering section, the print data relating to the secure print job is transmitted by the print data transmitting section to the image forming apparatus to be printed by the print engine.

In this way, the process request and the authentication information relating to the secure print job that do not take up a storage capacity of a job memory of the image forming apparatus very much are stored in the image forming apparatus beforehand and the print data tending to take up a large part of the storage capacity of the job memory of the image forming apparatus is transmitted to the image forming apparatus to be printed when the print permission of the secure print job from the image forming apparatus is obtained.

Thus, a capacity shortage of the job memory of the image forming apparatus can be prevented without requiring the user to set a valid period (deletion period or deletion time) for each secure print job.

Accordingly, a novel printer driver device can be provided which can prevent a capacity shortage of a job memory without impairing user convenience when an image forming apparatus receives secure print jobs without limitation.

In the above construction, the process request transmitting section preferably sets authentication information common to secure print jobs as authentication information relating to the respective secure print jobs and to be transmitted to the image forming apparatus when print data relating to a plurality of secure print jobs are accumulated in the secure print data accumulating section.

According to this construction, time and effort for an operation for authentication upon an actual output of the respective secure print jobs can be reduced as compared with the case where authentication information is individually set for each secure print job.

In the above construction, the secure print data accumulating section preferably combines print data relating to a plurality of secure print jobs into a single print data when the print data relating to the plurality of secure print jobs are accumulated.

According to this construction, the print data relating to the respective secure print jobs needs not be managed for each secure print job and can be managed in a unified manner since the print data relating to the respective secure print jobs are combined into the single print data.

In the above construction, the process request transmitting section preferably sets authentication information common to secure print jobs as authentication information relating to the respective secure print jobs and to be transmitted to the image forming apparatus when print data relating to a plurality of secure print jobs are combined into a single print data in the secure print data accumulating section.

According to this construction, time and effort for an operation for authentication upon an actual output of the respective secure print jobs can be reduced as compared with the case where authentication information is individually set for each secure print job.

An image forming apparatus according to still another aspect of the present invention including a print engine for printing a print data relating to a secure print job upon receiving an instruction from a user terminal comprises a process request registering section for receiving and registering a process request of the secure print job and authentication information relating to the secure print job; an operation information obtaining section for obtaining operation information indicating the authentication information relating to the secure print job; a secure print job searching section for searching a secure print job relating to the authentication information indicated by the operation information from registered contents of the process request registering section every time the operation information indicating the authentication information is obtained by the operation information obtaining section; and a print permission issuing section for issuing a print permission of the extracted secure print job to the corresponding user terminal when the corresponding secure print job is extracted by the secure print job searching section.

According to this construction, the process request of the secure print job and the authentication information relating to the secure print job are received and registered by the process request registering section. Every time the operation information indicating the authentication information relating to the secure print job is obtained by the operation information obtaining section, the secure print job relating to the authentication information indicated by the operation information is searched from the registered contents of the process request registering section by the secure print job searching section.

When the corresponding secure print job is extracted by the secure print job searching section, the print permission of the secure print job is issued to the user terminal by the print permission issuing section to obtain the print data relating to the secure print job from the user terminal.

In this way, the process request and the authentication information relating to the secure print job that do not take up a storage capacity of a job memory of the image forming apparatus very much are stored at first and the actual print data tending to take up a large part of the storage capacity of the job memory of the image forming apparatus is obtained when the operation information indicating the authentication information coinciding with the authentication information stored beforehand is obtained.

Thus, a capacity shortage of the job memory of the image forming apparatus can be prevented without requiring the user to set a valid period (deletion period or deletion time) for each secure print job.

Accordingly, a novel image forming apparatus can be provided which can prevent a capacity shortage of a job memory without impairing user convenience when an image forming apparatus receives secure print jobs without limitation.

A storage medium according to further another aspect of the present invention stores a printer driver for, upon receiving an instruction from a user terminal, causing the user terminal connected to an image forming apparatus including a print engine for printing a print data relating to a secure print job to function as a process request transmitting section for transmitting a process request of the secure print job and authentication information relating to the secure print job to the image forming apparatus; a secure print data accumulating section for temporarily accumulating a print data relating to the secure print job; a print permission obtaining section for obtaining the print permission of the secure print job from the image forming apparatus having received the process request and the authentication information relating to the secure print job and registered them in a process request registering section; and a print data transmitting section for causing the print engine to print the print data by transmitting the print data relating to the secure print job to the image forming apparatus when the print permission of the secure print job is obtained.

According to this construction, the user terminal operates as follows when the stored printer driver is installed in the user terminal.

Specifically, the user terminal causes the print data relating to the secure print job to be temporarily accumulated in the secure print data accumulating section and transmits the process request and the authentication information relating to the secure print job to the image forming apparatus using the process request transmitting section.

When the print permission of the secure print job is obtained by the print permission obtaining section from the image forming apparatus having registered the process request and the authentication information relating to the secure print job in the process request registering section, the print data relating to the secure print job is transmitted by the print data transmitting section to the image forming apparatus to be printed by the print engine.

In this way, the process request and the authentication information relating to the secure print job that do not take up a storage capacity of a job memory of the image forming apparatus very much are stored at first in the image forming apparatus and the actual print data relating to the secure print job and tending to take up a large part of the storage capacity of the job memory of the image forming apparatus is transmitted to the image forming apparatus to be printed when the print permission of the secure print job is obtained from the image forming apparatus.

Thus, a capacity shortage of the job memory of the image forming apparatus can be prevented without requiring the user to set a valid period (deletion period or deletion time) for each secure print job.

In the above construction, the process request transmitting section preferably sets authentication information common to secure print jobs as authentication information relating to the respective secure print jobs and to be transmitted to the image forming apparatus when print data relating to a plurality of secure print jobs are accumulated in the secure print data accumulating section.

According to this construction, time and effort for an operation for authentication upon an actual output of the respective secure print jobs can be reduced as compared with the case where authentication information is individually set for each secure print job.

In the above construction, the secure print data accumulating section preferably combines print data relating to a plurality of secure print jobs into a single print data when the print data relating to the plurality of secure print jobs are accumulated.

According to this construction, the print data relating to the respective secure print jobs need not be managed for each secure print job and can be managed in a unified manner since the print data relating to the respective secure print jobs are combined into the single print data.

In the above construction, the process request transmitting section preferably sets authentication information common to secure print jobs as authentication information relating to the respective secure print jobs and to be transmitted to the image forming apparatus when print data relating to a plurality of secure print jobs are combined into a single print data in the secure print data accumulating section.

According to this construction, time and effort for an operation for authentication upon an actual output of the respective secure print jobs can be reduced as compared with the case where authentication information is individually set for each secure print job.

This application is based on Japanese patent application serial No. 2009-100501 filed in Japan Patent Office on Apr. 17, 2009, the contents of which are hereby incorporated by reference.

The specific embodiments and examples in the detailed description of the invention are merely intended to clarify the technical contents of the present invention. Therefore, it is understood that the present invention should not be interpreted narrowly within only these embodiments and examples, and various modifications and variations can be devised within the scope of the spirit of the present invention and the following claims.

What is claimed is:

1. A secure printing system, comprising:
an image forming apparatus including a print engine for printing a print data relating to a secure print job when the print data is transmitted thereto; and
a user terminal having a printer driver for controlling the operation of the print engine installed therein and so constructed as to be able to instruct secure printing to the image forming apparatus,
wherein:
the image forming apparatus includes:
a process request registering section for receiving and registering a process request of the secure print job and authentication information relating to the secure print job;
an operation information obtaining section for obtaining operation information indicating the authentication information relating to the secure print job;
a secure print job searching section for searching a secure print job relating to the authentication information indicated by the operation information from registered contents of the process request registering section every time the operation information indicating the authentication information is obtained by the operation information obtaining section; and
a print permission issuing section for issuing a print permission of the extracted secure print job to the corresponding user terminal when the corresponding secure print job is extracted by the secure print job searching section, and
the user terminal includes:
a process request transmitting section for transmitting the process request of the secure print job and the authentication information relating to the secure print job to the image forming apparatus;
a secure print data accumulating section for temporarily accumulating a print data relating to the secure print job;
a print permission obtaining section for obtaining the print permission of the secure print job from the image forming apparatus having received the process request and the authentication information relating to the secure print job and registered them in the process request registering section; and
a print data transmitting section for causing the print engine to print the print data by transmitting the print data relating to the secure print job to the image forming apparatus when the print permission of the secure print job is obtained.

2. A printer driver device for controlling the operation of a print engine for printing a print data when the print data relating to a secure print job is transmitted, comprising:
a process request transmitting section for transmitting a process request of the secure print job and authentication information relating to the secure print job to an image forming apparatus;
a secure print data accumulating section for temporarily accumulating a print data relating to the secure print job;
a print permission obtaining section for obtaining the print permission of the secure print job from the image forming apparatus having received the process request and the authentication information relating to the secure print job and registered them in a process request registering section; and
a print data transmitting section for causing the print engine to print the print data by transmitting the print data relating to the secure print job to the image forming apparatus when the print permission of the secure print job is obtained.

3. A printer driver device according to claim 2, wherein the process request transmitting section sets authentication information common to secure print jobs as authentication information relating to the respective secure print jobs and to be transmitted to the image forming apparatus when print data relating to a plurality of secure print jobs are accumulated.

4. A printer driver device according to claim 2, wherein the secure print data accumulating section combines print data relating to a plurality of secure print jobs into a single print data when the print data relating to the plurality of secure print jobs are accumulated.

5. A printer driver device according to claim 4, wherein the process request transmitting section sets authentication information common to secure print jobs as authentication information relating to the respective secure print jobs and to be transmitted to the image forming apparatus when print data relating to a plurality of secure print jobs are combined into a single print data in the secure print data accumulating section.

6. An image forming apparatus including a print engine for printing a print data relating to a secure print job upon receiving an instruction from a user terminal, comprising:
a process request registering section for receiving and registering a process request of the secure print job and authentication information relating to the secure print job;
an operation information obtaining section for obtaining operation information indicating the authentication information relating to the secure print job;
a secure print job searching section for searching a secure print job relating to the authentication information indicated by the operation information from registered contents of the process request registering section every time the operation information indicating the authentication information is obtained by the operation information obtaining section; and
a print permission issuing section for issuing a print permission of the extracted secure print job to the corresponding user terminal when the corresponding secure print job is extracted by the secure print job searching section.

7. A storage medium storing a printer driver for, upon receiving an instruction from a user terminal, causing the user terminal connected to an image forming apparatus including a print engine for printing a print data relating to a secure print job to function as:
a process request transmitting section for transmitting a process request of the secure print job and authentication information relating to the secure print job to the image forming apparatus;
a secure print data accumulating section for temporarily accumulating a print data relating to the secure print job;
a print permission obtaining section for obtaining the print permission of the secure print job from the image forming apparatus having received the process request and the authentication information relating to the secure print job and registered them in a process request registering section; and
a print data transmitting section for causing the print engine to print the print data by transmitting the print data relating to the secure print job to the image forming apparatus when the print permission of the secure print job is obtained.

8. A storage medium according to claim 7, the process request transmitting section sets authentication information common to secure print jobs as authentication information relating to the respective secure print jobs and to be transmitted to the image forming apparatus when print data relating to a plurality of secure print jobs are accumulated in the secure print data accumulating section.

9. A storage medium according to claim 7, wherein the secure print data accumulating section combines print data relating to a plurality of secure print jobs into a single print data when the print data relating to the plurality of secure print jobs are accumulated.

10. A storage medium according to claim 9, wherein the process request transmitting section sets authentication information common to the respective secure print jobs as authentication information relating to the respective secure print jobs and to be transmitted to the image forming apparatus when the print data relating to the plurality of secure print jobs are combined into the single print data in the secure print data accumulating section.
